(19) United States
(12) Patent Application Publication
(10) Pub. No.: US 2011/0048256 A1
(43) Pub. Date: Mar. 3, 2011

(54) Method and System for Producing a Cover for a Device

(75) Inventors: John Raymond Atta, Box Hill North (AU); Grant Russell Taylor, Heidelberg (AU)

(73) Assignee: GRAPHIX LABELS PTY. LTD., Burwood, VI (AU)

(21) Appl. No.: 12/602,637

(22) PCT Filed: May 30, 2008
(86) PCT No.: PCT/AU08/00777

§ 371 Date: Aug. 19, 2010

(30) Foreign Application Priority Data
Jun. 1, 2007 (AU) 2007902978

(51) Int. Cl. B41L 19/00

(52) U.S. Cl. 101/45

(57) ABSTRACT

Some described embodiments relate to a method of producing a cover for a device. The method comprises receiving selection input at a computerised interface, the selection input comprising a device selection of the device and a cover selection of a decorative cover to be applied to the device; generating a product order based on the selection input; providing a sheet to a cutting apparatus, wherein a decorative appearance of the sheet corresponds to the cover selection and the sheet comprises a flexible adhesive-backed substrate on which the decorative appearance is printed and a backing layer; and causing the cutting apparatus to cut the substrate based on the product order so that at least one portion of the substrate is separable from a remainder of the substrate and the backing layer to form the decorative cover for adhesive application to the device.

### TECHNICAL FIELD

Described embodiments relate to methods and systems for producing a cover for a device. Described embodiments also relate to a retail establishment comprising the system. The cover may be decorative and/or protective.

### BACKGROUND

Hand held devices, such as mobile telephony and/or music playing devices, have become prevalent in recent times. Often, such devices are relatively visually featureless.

Some products are available on the market for decorating or otherwise visually enhancing or distinguishing the appearance of electronic devices. Such products are generally pre-fabricated and pre-packaged and have a visually distinctive appearance. However, the vendor or supplier of such products can be left with a large amount of unsold stock if a design is unpopular or when the physical characteristics of the device are changed (or the device is discontinued), thereby rendering the decorative product unsuitable for its intended application.

It is desired to address or ameliorate one or more shortcomings associated with existing techniques for producing decorative covers for devices, or to at least provide a useful alternative thereto.

### SUMMARY

Certain embodiments relate to a method of producing a decorative cover for a device. The method comprises receiving selection input at a computerised interface, the selection input comprising a device selection of the device and a cover selection of a decorative cover to be applied to the device. The method further comprises generating a product order based on the selection input. The method further comprises providing a sheet to a cutting apparatus, wherein a decorative appearance of the sheet corresponds to the cover selection and the sheet comprises a flexible adhesive-backed substrate on which the decorative appearance is printed and a backing layer. The method further comprises causing the cutting apparatus to cut the substrate based on the product order so that at least one portion of the substrate is separable from a remainder of the substrate and the backing layer to form the decorative cover for adhesive application to the device.

The adhesive on the substrate may be selected to leave substantially no residue on the device if applied to and removed from the device.

The providing may comprise printing the decorative appearance on a first face of a length of material comprising the substrate, applying a clear self-adhesive layer to the front face and cutting the length of material to provide the sheet. The cutting may provide a plurality of the sheets. The method may further comprise applying a primer to the first face prior to the printing.

The printing may comprise printing identification indicia on the length of material for each sheet to be cut from the length of material and the cutting may comprise cutting the length of material so that each sheet has the identification indicia thereon. The identification indicia may correspond to the cover selection.

The generating may comprise printing a product specification on a physical medium based on the product order. The printing may comprise printing a machine-readable code and at least one human-readable code on the physical medium. The machine-readable code may be usable by a product sales system to identify the sheet and to process a sale of a sheet. The at least one human-readable code may comprise a sheet identifier to enable human identification of the sheet to be cut by the cutting apparatus. One or more of the at least one human-readable code and the machine-readable code may comprise a job identifier and the cutting apparatus may be configured to cut the substrate based on the job identifier. The generating may comprise storing a product order file in a memory accessible to the cutting apparatus, the product order file comprising a job identifier and a cutting pattern for cutting the portions of the substrate. The causing may comprise providing the job identifier to the cutting apparatus and retrieving of the product order file from the memory based on matching the provided job identifier with the stored job identifier.

The method may further comprise presenting at the computerised interface a plurality of device representations and determining the device selection in response to selection of one of the device representations. The method may further comprise presenting at the computerised interface a plurality of decorative images and determining the cover selection in response to selection of one of the decorative images.

The method may further comprise displaying a preview image comprising one of the decorative images applied to a representation of a selected device. The preview image may comprise decorative image portions corresponding to the separable portions of the substrate, the decorative image portions being positioned in relation to the representation of the selected device to visually simulate application of the decorative cover to the device.

The receiving and generating may be performed at a customer-accessible computerised kiosk in a retail establishment and the providing and causing may be performed at one or more locations within the retail establishment that are not customer-accessible. Alternatively, the method is performed within a retail establishment at one or more locations that are not customer-accessible. Alternatively, the receiving and generating may be performed by a server system in communication with a client system that is remote from a retail establishment in which the providing and causing are performed.

Other embodiments relate to a system for producing a decorative cover for a device. The system comprises a computerised interface configured to enable receipt of selection input, the selection input comprising a device selection of the device and a cover selection of a decorative cover to be applied to the device, the computerised interface being further configured to generate a product order based on the selection input. The system further comprises a plurality of sheets, each sheet having a decorative appearance, the decorative appearance of at least one sheet corresponding to the cover selection, wherein each sheet comprises a flexible adhesive-backed substrate on which the decorative appearance is printed and a backing layer. The system further comprises a cutting apparatus configured to cut the substrate of a selected one of the sheets based on the product order so that at least one portion of the substrate is separable from a remainder of the substrate and the backing layer to form the decorative cover for adhesive application to the device.

The plurality of sheets may each comprise a clear self-adhesive layer covering a face of the sheet on which the decorative appearance is printed. Each sheet may have printed thereon identification indicia.

The system may further comprise a printer operably associated with the computerised interface for printing a product specification on a physical medium based on the product order. The product specification may comprise a machine-readable code and at least one human-readable code. The machine-readable code may be usable by a product sales system to identify the sheet and to process a sale of a sheet. The at least one human-readable code may comprise a sheet identifier to enable human identification of the sheet to be cut by the cutting apparatus. One of the at least one human-readable code and the machine-readable code may comprise a job identifier and the cutting apparatus may be configured to cut the substrate based on the job identifier.

The computerised interface may be configured to store in a memory accessible to the cutting apparatus a product order file for each product order, the product order file comprising a job identifier and a cutting pattern for cutting the portions of the substrate. The cutting apparatus may be configured to retrieve the cutting pattern for a sheet based on the job identifier in the product order file in response to input of the job identifier to the cutting apparatus.

The computerised interface may be configured to present a plurality of device representations to enable receipt of the device selection from among the device representations. The computerised interface may be configured to present a plurality of decorative images to enable receipt of the cover selection from among the decorative images. The computerised interface may be configured to display a preview image comprising one of the decorative images applied to a representation of a selected device. The preview image may comprise decorative image portions corresponding to the separable portions of the substrate, the decorative image portions being positioned in relation to the representation of the selected device to visually simulate application of the decorative cover to the device.

The computerised interface may be comprised in a customer-accessible kiosk within a retail establishment and the cutting apparatus may be located within the retail establishment in a location that is not customer-accessible. Alternatively, the computerised interface and cutting apparatus may be located within a retail establishment in an area that is not customer-accessible. Alternatively, the computerised interface may be located remotely from a retail establishment in which the plurality of sheets and the cutting apparatus are located, the computerised interface being in communication with a server system to enable the cutting apparatus to access the product order.

Other embodiments relate to a retail establishment comprising any of the systems described above.

Further embodiments relate to computer-readable storage storing program code which, when executed by at least one processing device, causes the at least one processing device to perform any of the methods described herein.

Further embodiments relate to a decorative cover for a device, the decorative cover being produced by any of the methods described herein.

Other embodiments relate to a method of producing a protective cover for a device. The method comprises receiving selection input at a computerised interface, the selection input comprising a device selection of the device and a cover selection of a protective cover to be applied to the device. The method further comprises generating a product order based on the selection input. The method further comprises providing a sheet to a cutting apparatus, wherein the sheet corresponds to the cover selection and the sheet comprises a protective flexible adhesive-backed substrate and a backing layer. The method further comprises causing the cutting apparatus to cut the substrate based on the product order so that at least one portion of the substrate is separable from a remainder of the substrate and the backing layer to form the protective cover for adhesive application to the device.

The protective cover may be a clear screen protector for protecting a display screen of the device.

The adhesive on the substrate may be selected to leave substantially no residue on the device if applied to and removed from the device.

Other embodiments relate to a system having components configured to perform any of the described methods of producing a protective cover for a device.

### BRIEF DESCRIPTION OF THE DRAWINGS

Embodiments are described in further detail, by way of example, with reference to the accompanying drawings, in which:

FIG. 1 is a block diagram of a system for producing a decorative cover for a device;

FIG. 2 is a block diagram of an alternative system for producing a decorative cover for a device;

FIG. 3 is a block diagram of a further alternative system for producing a decorative cover for a device;

FIG. 4 is a schematic diagram of a computerised kiosk usable with some embodiments of the system for producing a decorative cover;

FIG. 5 is a block diagram showing software components of the system in further detail;

FIGS. 6A and 6B are flowcharts of a method of producing a decorative cover for a device;

FIG. 7 is a schematic diagram of a product specification;

FIG. 8 is a flowchart of a method of producing a decorative cover for a device;

FIG. 9 is a schematic diagram of sheet material for use in producing decorative covers;

FIG. 10 is a cross-sectional view of the sheet material;

FIG. 11 is a schematic diagram of a sheet that has been cut according to a method of producing a decorative cover;

FIG. 12 is a front view of an example device to which an example decorative cover has been applied;

FIG. 13 is a rear view of the device of FIG. 12; and

FIG. 14 is a screen shot of a display of a computerised interface of the system.

### DETAILED DESCRIPTION

The described embodiments relate generally to methods and systems for producing a decorative cover for a device, such as a hand held electronic device, a laptop/portable computer, a digital personal music player (e.g. an MP3 player such as Apple's ‘iPod’), a mobile/cellular telephone (including a mobile Personal Digital Assistant such as Research In Motion's ‘Blackberry’), a cordless telephone, a cup (e.g. a coffee mug, tea cup or water cup), a saucer, a pocket calculator, a audio recoding device (e.g. a dictaphone), a video gaming console (e.g. Microsoft's ‘X-Box’ or Sony's ‘PlayStation’), a musical instrument (e.g. a guitar, hand-held microphone, flute, trumpet, trombone, tuba, electronic keyboard, piano, violin, viola, cello, bassoon, clarinet, oboe, etc), an office stationary item (e.g. stapler, hole punch, desk telephone, clock, digital memory stick, etc), or any medium-to-small sized device.

The described embodiments also relate to the decorative cover produced by such methods. Further embodiments relate to a retail establishment comprising the system. In such embodiments, the system may comprise a split system located partially in customer accessible areas of the retail establishment and partially in non-customer accessible (restricted) areas of the retail establishment. In alternative embodiments, the system may be located in an area of the retail establishment that is not accessible to customers. In further alternative embodiments, part of the system may be remotely located relative to the retail establishment.

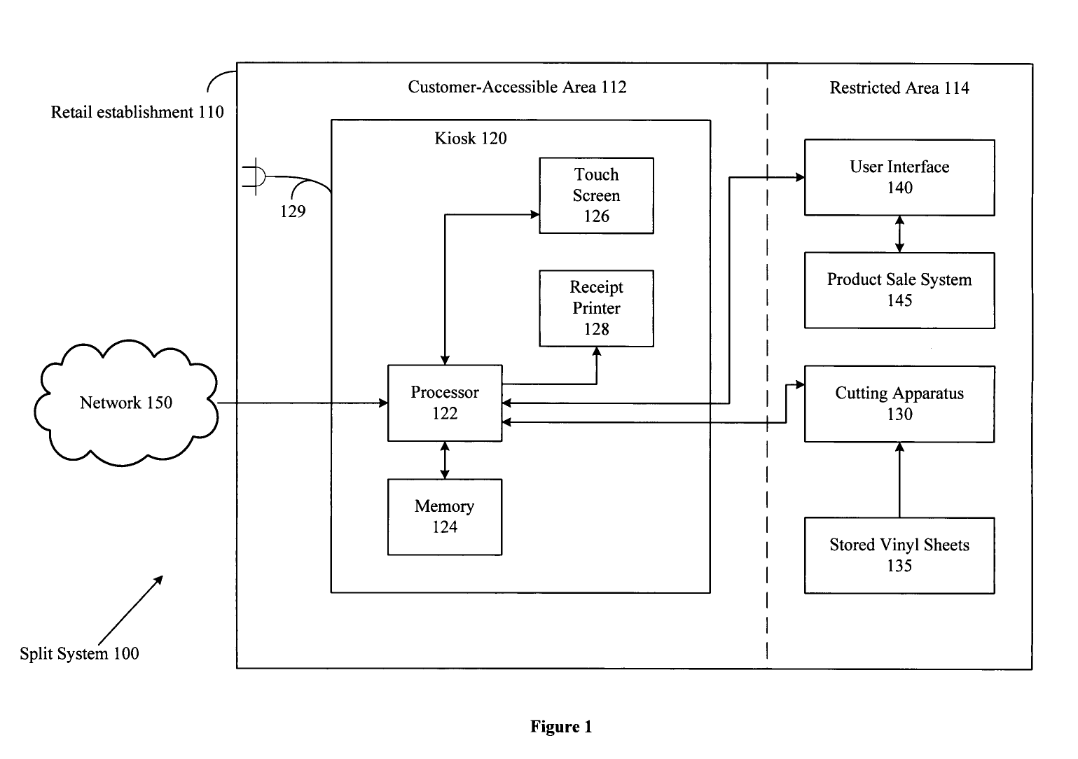

A split system 100 for producing a decorative cover for a device includes a retail establishment 110 which is divided into a customer accessible area 112 and a restricted area 114, as shown in FIG. 1. The customer accessible area 112 includes a customer accessible computerised kiosk 120 that can be used by a customer to order or specify or select the customised or personalised, decorative cover for a device. The kiosk 120 includes a processor 122 which interacts with a computer memory 124 to display an interface on the touch screen 126 which allows the customer to provide selection input that includes a device selection, to select to which device the decorative cover is to be applied, and cover selection, defining the pattern or decoration which is desired for the decorative cover. Instead of a touch-screen, other suitable computer peripheral devices may be used to accomplish the same user interface functionality.

The kiosk 120 generates a product order based on the selection input and generates a product order file in the memory 124. The kiosk 120 provides the customer with a product specification, such as a docket 420, on a physical medium, such as a piece of paper, using the receipt printer 128. The product specification, based on the product order, includes a machine-readable code, and at least one human-readable code. The machine-readable code is for use by a product sale system 145 to identify the sheet and to process a sale of the sheet. The human-readable code includes a sheet identifier to enable human identification of the sheet to be cut by the cutting apparatus. The human-readable code and/or the machine-readable code comprise a job identifier used to configure a cutting apparatus 130 to cut a substrate of the sheet.

The cutting apparatus 130 may be a vector graphics vinyl cutting device, such as a ‘CE5000’ series cutting plotter from ‘Graphtec Corp.’ (URL: http://www.graphteccorp.com/).

The kiosk 120 includes a power cord 129 for connection to a source of electrical power for powering the kiosk during operation.

The processor 122 of the kiosk 120 is in communication with the cutting apparatus 130 in the restricted area 114, as shown in FIG. 1. The processor 122 sends product order data, representing the product order, to the cutting apparatus 130 once a customer order has been completed by the kiosk 120. The cutting apparatus 120 uses the device selection, represented in device selection data, to generate a cutting pattern, based on “die line code”, corresponding to the selected device. The cutting pattern may be manually or automatically designed based on actual physical dimensions and characteristics of the device to which the cover is to be applied. For example, the cutting pattern takes into account the shape of the selected device, the size and any user interface features such as sockets, buttons, microphones, speakers and/or screens. For each product order, the cutting apparatus 130 cuts a cutting pattern into and/or through the substrate of the sheet, which has already been pre-printed with a decoration, selected from a store of stored sheets 135. The appropriate sheet is selected based on cover selection data representing the cover selection by the customer.

The substrate of the stored sheets 135 comprises a printable material, such as a flexible vinyl, that is able to stretch and flex to conform to curved surfaces of the device.

The cutting apparatus 130, while cutting the sheet based on the cutting pattern, cuts through a decorated layer of the sheet to allow separation of the decorative cover for the device from the remainder of the sheet, i.e. separation of the parts that are used to decorate the device from the parts that are not used (such as the backing layer, scraps on the edges, or where windows are cut for user interface features). The cuts made by the cutting device may be shallow, cutting through or mostly through the decorated substrate layer, or deep, cutting up to all of the layers of the sheet, including the backing layer.

The restricted area 114, which may be behind a service counter in the retail establishment 110, includes a user interface 140 for use by a sales assistant, or cashier, who assists with the supply of the decorative cover to the customer. The user interface 140 may receive the product order data from the processor 122 of the kiosk 120, which allows the sales assistant to view the customer's order and/or input a job number to allow the cutting apparatus 130 to identify and execute the correct cutting pattern (as described below). The user interface 140 is in communication with the product sales system 145, e.g. a Point Of Sale (POS) system or cash register, which allows the sales assistant and the customer to exchange payment for the decorative cover provided by the cutting apparatus 130.

The cutting apparatus 130 accesses a predetermined cutting pattern for each device which may be selected by the customer. The data representing each predetermined cutting pattern is accessed by the cutting apparatus 130 in a memory, such as a memory (not shown) of the cutting apparatus, a memory 124 of the kiosk 120, or memory storage available over a data network 150 in communication with the processor 122 of the kiosk 120. Each predetermined cutting pattern is predetermined based on dimensional measurements of its corresponding device, conventional measurements of the vinyl sheets in the stored sheets 135, and/or physical properties (e.g. stretch and/or compliance) of the stored sheets 135.

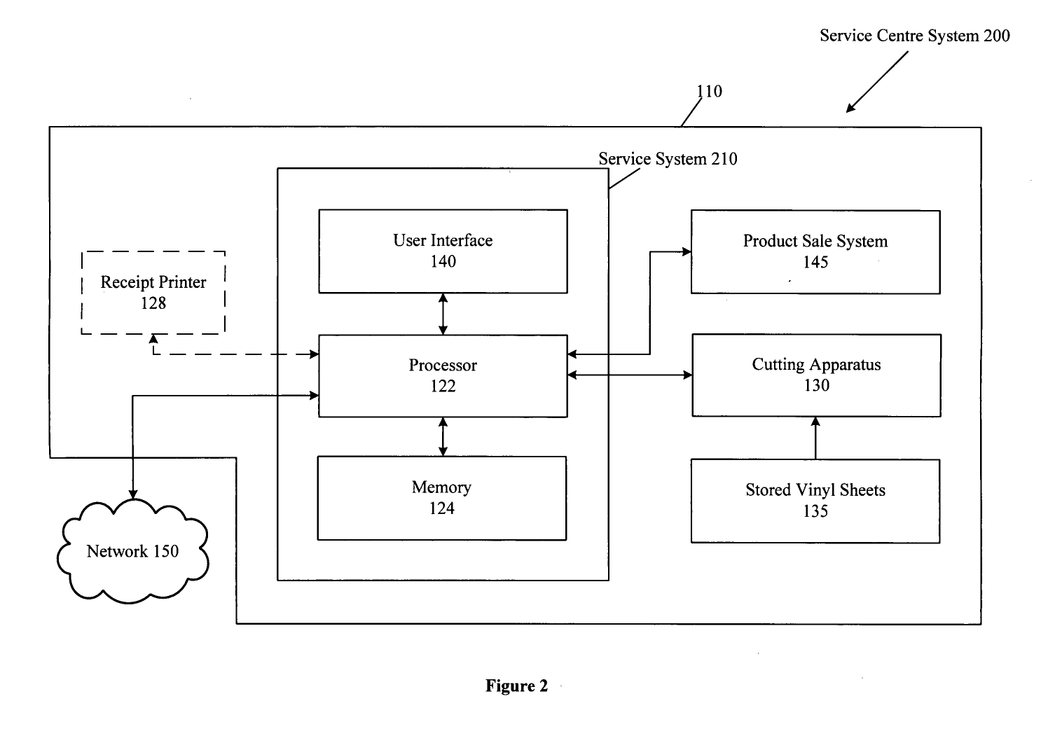

Embodiments of the system for producing a decorative cover for a device may be in the form of a service counter system 200 in which the processor 122, the memory 124, the receipt printer 128, the cutting apparatus 130, the stored sheets 135 and the product sales system 145 are all located within the restricted area 114 of the retail establishment 110, as shown in FIG. 2. To use the service counter system 200, the customer relates to the sales assistant their selection input, including the device selection and the cover selection, and the sales assistant generates the product order, represented by product order data, using the user interface 140 in a service system 210, e.g. a kiosk or computing device behind a service counter.

The processor 122 in the service counter system 200 may be in communication with the data network 150 external to the restricted area 114, as shown in FIG. 2.

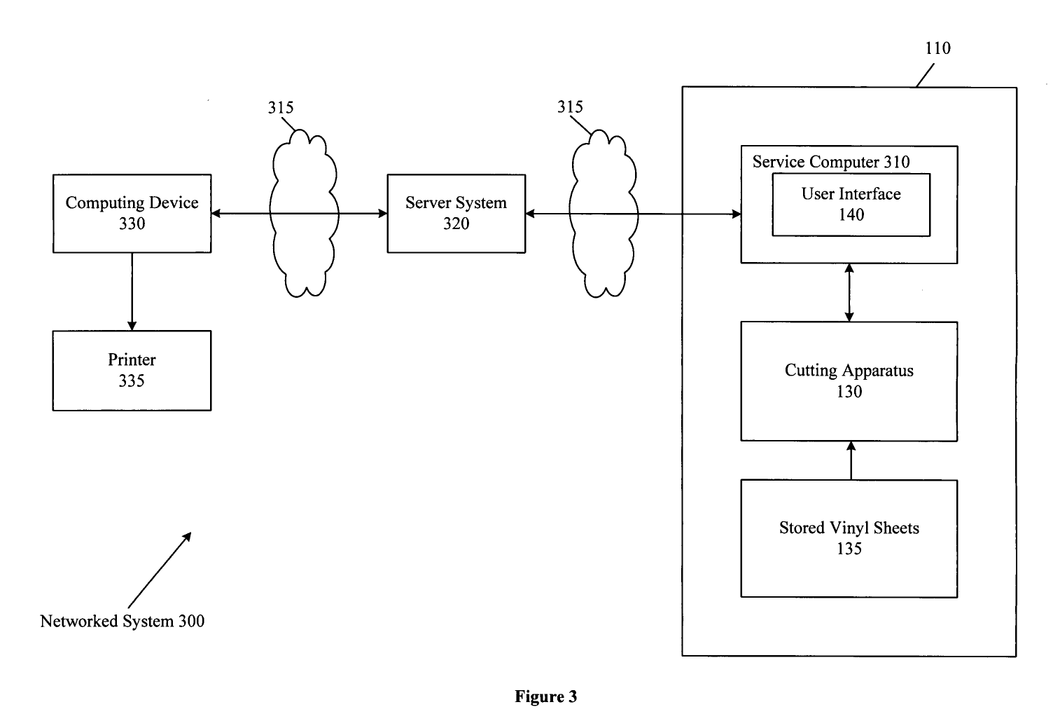

In further embodiments, the system for producing a decorative cover for a device may be in the form of a networked system 300, in which the customer generates the selection input using a computing device 330, e.g. a personal computer, and the selection input is sent to the retail establishment 110, which includes the cutting apparatus 130 and the stored sheets 135, using a public data network 315, e.g. the Internet, as shown in FIG. 3. The networked system 300 allows the customer to print the product specification, and/or a receipt, using a printer 335 in communication with a computing device 330.

The computing device 330 and the retail establishment 110 are in communication with a server system 320, as shown in FIG. 3, which provides for secure data exchange between the computing device 330 and a service computer 310 in the retail establishment 110. The server system 320, which includes the processor 122 and memory 124, provides functionality similar to that of the kiosk 120 to a user of the computing device 330 by supporting a client program on the computing device in a client-server arrangement: the server system 320 serves data to the client program allowing the user, who is the customer, to generate the selection input on the computing device. The server system 320 generates the product order, based on the selection input, and sends this data to the retail establishment 110.

In the networked system 300, the service computer 310 receives the product order data either directly via the network 315 or using the product specification which is presented in the retail establishment 110 for entering the product order data via the user interface 140 (e.g. by manually entering data corresponding to the human-readable code, or automatically entering the data using the machine-readable code of the product specification). For example, a customer may select the decorative cover design and the device using the computing device 330 and print the docket 420 or receipt including the product specification using the printer 335, and then bring the docket 420 to the retail establishment 110 for production of the decorative cover for the device, using the cutting apparatus 130 and the stored sheets 135 as described above.

In the networked system 300, the available decorative covers and devices to be selected are provided to the computing device 330 via the network 315. The available decorative covers and devices are updated by an administrator of the system based on known available decorative sheets and devices. The available selections provided by the computing device 330 are coordinated with the available selections in the retail establishment 110 using communications via the network 315.

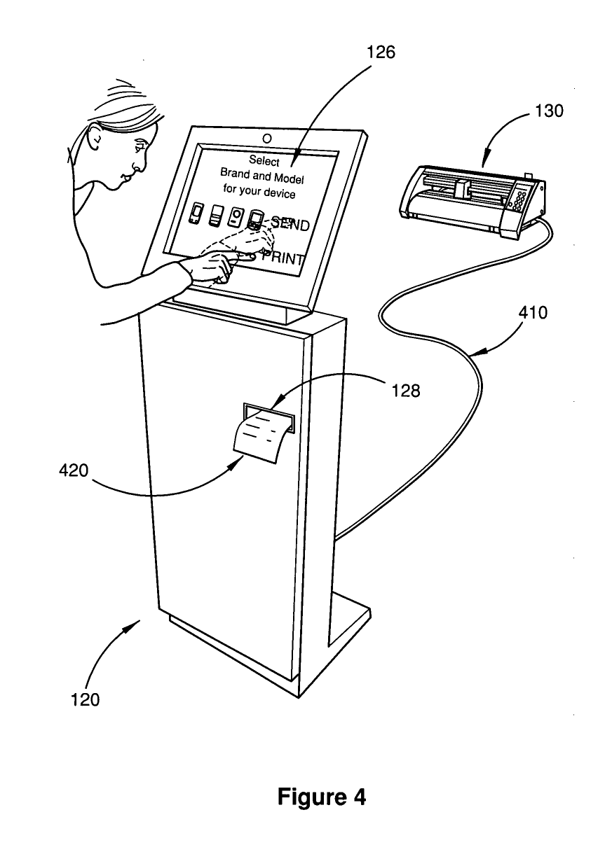

In an example of the kiosk 120, the receipt printer 128 prints the paper receipt or docket 420, as shown in FIG. 4. Kiosk 120 includes the touch screen 126 mounted on a top portion of a housing of the kiosk 120. Processor 122 and memory 124 may be located within the kiosk housing. The kiosk 120 is connected to the cutting apparatus by a data communication cable 410 for transmitting the product order data.

The processor 122 accesses data in a memory system 502 for use during generation of the selection input and product order data. The memory system 502 may be localised, e.g. in the memory 124 of the kiosk 120 or of the service system 210, or may be distributed using memory components, e.g. in the retail establishment 110, the server system 320 and/or accessible via the data networks 150, 315. The memory system 502 includes program code for executing a user interface module 510, e.g. in the form of computer code, which provides for the operation of the user interface 140 and the touch screen 126.

The memory system 502 includes program code for executing a printer driver 520 for controlling the receipt printer 128 and/or the printer 335, for the data input, formatting and printing of the product specification (including the machine-readable code and the human-readable code) and/or a purchase receipt.

The memory system 502 includes product order storage 530 for storing the product order data of current and previous device and cover selections. The product order storage 530 receives the product order data from the processor 122 based on the selection input and sends the product order data to the cutting apparatus as described above.

In certain embodiments, the memory system 502 includes a file conversion module 540 for converting the product order data between a visual display format, e.g. the Joint Photographic Experts Group (JPEG) format, and a machine-readable format for the cutting apparatus 130, e.g. a die-line cutting format associated with the device selection data. Other embodiments include pairs of matching files for the graphic display (to the customer during selection) and the cutting pattern (for the cutting apparatus 130), with one pair for each available device.

The memory system 502 includes die line storage 550 for storing the cutting patterns associated with the devices available for selection by the customer, i.e. the predetermined cutting patterns associated with available devices. The cutting pattern data is in a form corresponding to the cutting apparatus 130, e.g. a vector graphics format for a vector graphics plotter.

The memory system 502 includes stored pages 560 represented by stored page data and/or code, which are used to generate the user interface for the customer. The stored pages 560 are used to generate the screens that the customer sees during selection of their device and decoration. The stored pages 560 include a list of available devices for selection by the customer. The stored pages 560 are used by the processor 122 to generate device representations, in the form of images of the devices, representing devices which are available for the customer to select.

The memory system 502 includes decorative patterns 570, represented by decorative pattern data, which provide an up-to-date list of available decorations. The decorative patterns 570 are used by the processor 122 to generate decorative images of how a selected device may appear with a selected cover. The decorative pattern data may be stored together with data to enable selection of a protective screen for a particular selected device.

Die line storage 550, stored pages 560 and decorative patterns 570 may be regularly updated or re-configured via the network 150 or by insertion of a data storage medium into kiosk 120, service system 210 or server system 320.

The system for producing a decorative cover for a device performs a process 600 for producing a decorative cover for a device, using customised and personalised input from the customer. The process may be performed by the kiosk 120, the service system 210, or the server system 320 in conjunction with the client program running on the computing device 330.

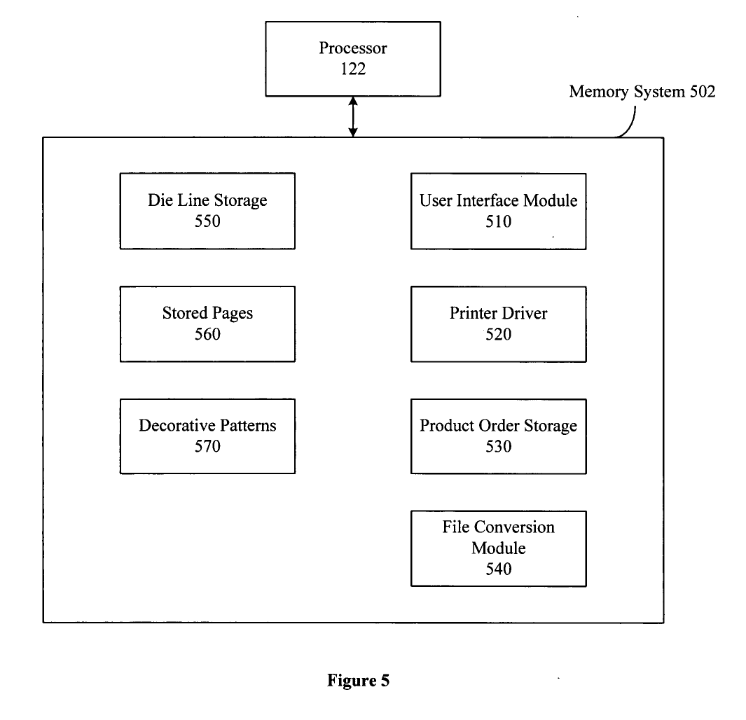

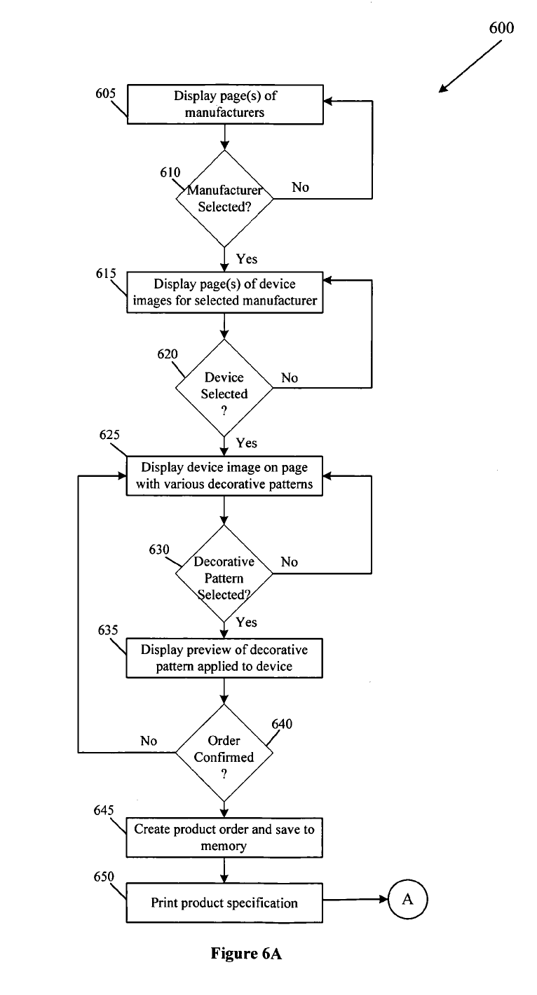

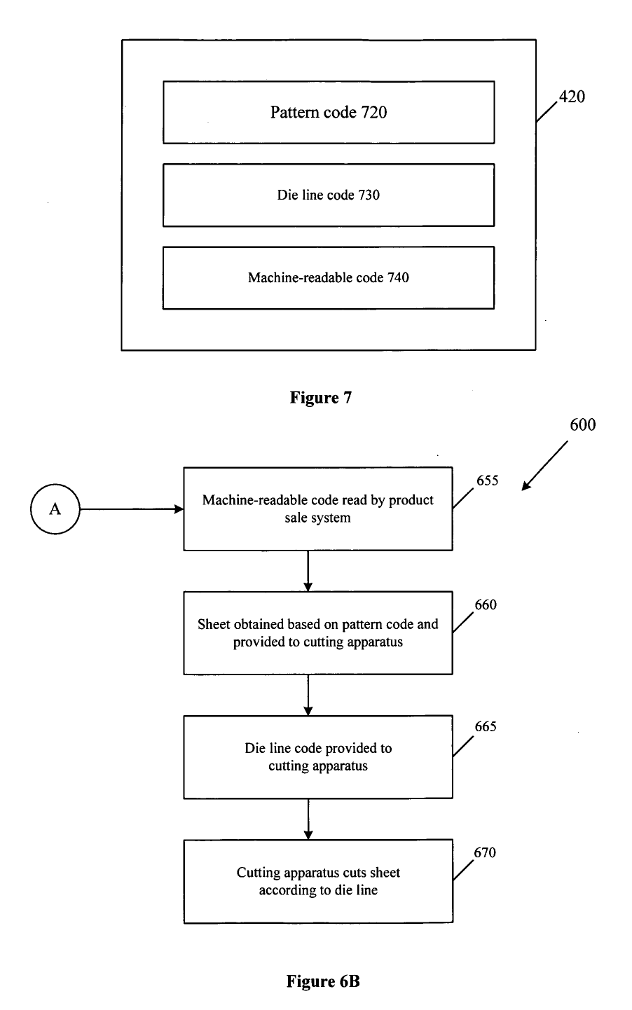

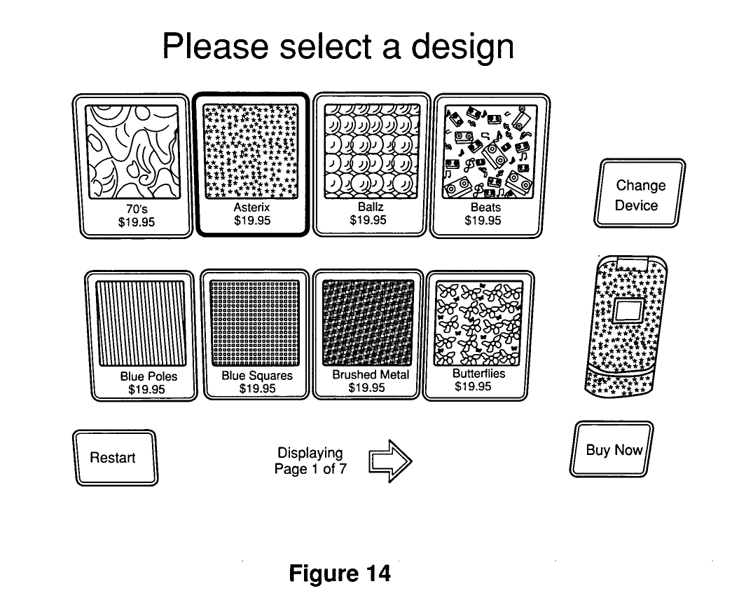

The process 600 for producing a customised decorative cover for a device commences with the system displaying one or more pages of available device manufacturers, e.g. Olympus, Sony, Research In Motion, Lenovo, NEC, Apple Computers, Nokia etc., representing the manufacturers of available devices in the system (step 605), as shown in FIG. 6A. If the system determines that the customer has selected a manufacturer (step 610) the system displays one or more pages of device images corresponding to available devices of the selected manufacturer (step 615). The customer may then select their preferred device by indicating an image of the device. If the system determines that a device has been selected (step 620) the system displays one or more pages of decorative patterns available for selection (step 625). If the customer selects one of the decorative patterns displayed (step 630), the system displays a preview image of the device with the pattern applied on the screen with the other available decorative patterns, e.g. as shown in FIG. 14 (step 635).

The preview image of the decorated device in FIG. 14 corresponds to the decoration labelled ‘Asterix’, and the user interface indicates that this is the selected design by highlighting the design using a halo or other form of visual emphasis around this decorative pattern. The customer may then select to order this combination of device selection and cover selection, or to return to select a different decorative pattern by clicking on the different pattern (e.g. by clicking on the pattern marked ‘Beats’ in FIG. 14). The customer may also return to select a different device (e.g. by clicking on the user interface control marked ‘Change Device’ in FIG. 14) If the order is confirmed by the user (step 640), the system creates product order data representing a product order and saves this to the memory system 502 (step 645). If the order is not confirmed in step 640, the system again displays one or more pages of device images with various decorative patterns virtually applied, returning to step 625. Once the product order has been created, the system prints the product specification on a physical medium using the receipt printer 128 or the printer 335 (step 650).

The product specification may be in the form of the docket 420 including a printed human-readable pattern code 720, representing the selected cover (i.e. the selected decorative pattern), as shown in FIG. 7. The docket 420 also includes a human-readable die-line code 730 indicating a job number for the cutting pattern, or die line, corresponding to the device selection. The docket 420 also includes a printed representation of the machine-readable code 740, such as a barcode, which comprises a product identifier for the sheet to allow automatic reading of the product specification in a retail establishment 110, as described above. Code 740 may also comprise the job number.

In the process 600 for producing a decorative cover for a device, the machine-readable code of the product specification is automatically read by the product sales system 145 or the service computer 310 to allow a payment transaction corresponding to the product order to occur (step 655), as shown in FIG. 6B. The system may receive the product order data based on the product specification, or based on data transmitted over the data networks 150, 315. On receipt of the product order data, a sheet is selected corresponding to the cover selection, e.g. based on the pattern code 720 of the docket 420, and the sheet is provided to the cutting apparatus 130 (step 660). The sheet selection and provision may be automatic, using robotic equipment, or may be performed by the sales assistant or a sales technician operating the cutting apparatus 130. The system provides the cutting pattern to the cutting apparatus either using the die line code 730 of the docket 420 or based on cutting pattern data in the die line storage 550 associated with a selected device (step 665). The cutting apparatus cuts the sheet according to the cutting pattern (step 670) under control of the system. Once the sheet has been cut, the personalised decorative cover is provided to the customer for their selected device in exchange for payment, e.g. by the customer assistant in the retail establishment 110.

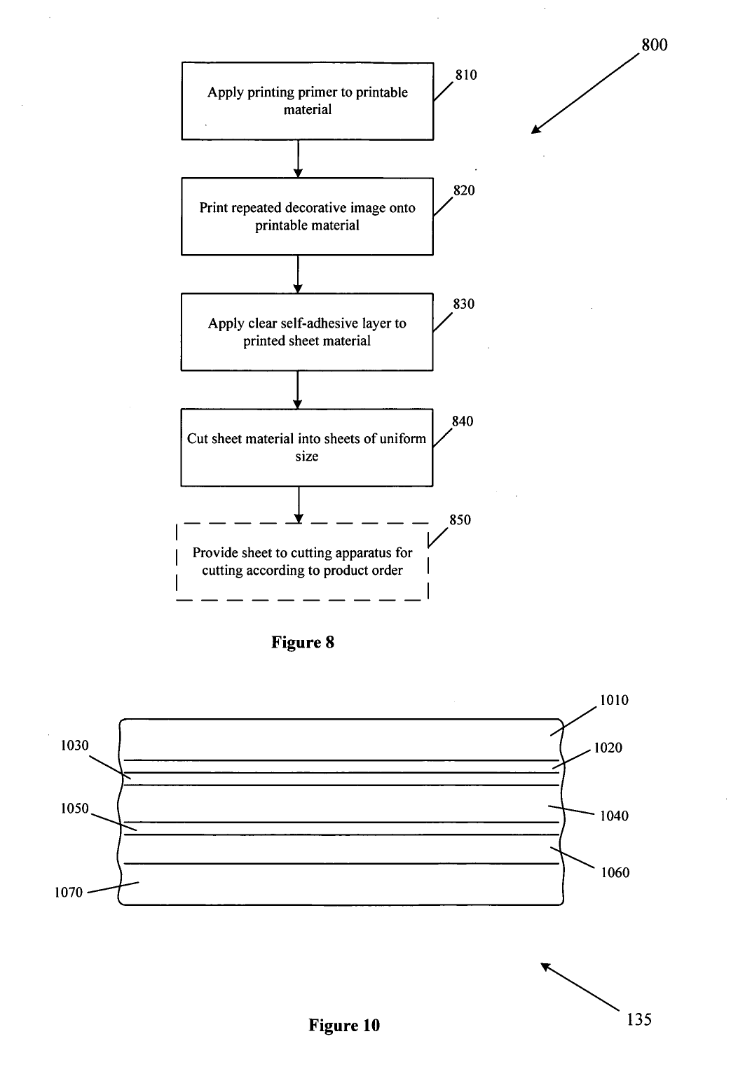

The sheets in the stored sheets 135 are produced in process 800 for producing a decorative cover for a device, which commences with the application of printing primer to a length of printable material (step 810), as shown in FIG. 8. The length of flexible printable material includes the adhesive-backed substrate and a separable backing layer.

The adhesive on the substrate is for example a removable acrylic, which leaves substantially no residue on the device if it is applied and subsequently removed. The adhesive forms an open, or honeycomb structure, allowing airflow to pass from underneath the cover as it is pressed onto a surface of the device, thereby avoiding air bubbles forming under the cover.

A decorative image, associated with decoration for a potential decorative cover, is repeatedly printed onto the printable material (step 820) to produce a length of the printable material with the repeated decorative image on a first face of the material. The repeated decorative image is printed onto a first face of the substrate, while the second face is separably adhered to the backing layer. A clear protective layer with a self-adhesive layer on one face is applied, over the decorative images, to the first face of the substrate, with the self-adhesive layer lying between the clear protective layer and the decoration (step 830). The length of material is cut into substantially uniform sheets of uniform size and dimension, to provide the sheets of the stored sheets 135 (step 840). Once sheets have been produced, they are provided to the cutting apparatus 130 for cutting based on the product order (step 850). The cutting apparatus 130 cuts the sheets down to the backing layer so that portions of the substrate are separable from a remainder of the substrate, and the backing layer, to form a decorative cover for adhesive application to the selected device, using the acrylic adhesive layer on the underside of the substrate.

An example sheet of the stored sheets 135 includes the following layers, layered in the following order, as shown in FIG. 10:
(i) the clear protective layer 1010;
(ii) a self-adhesive layer 1020;
(iii) the primer layer 1030 with the printed decorative image;
(iv) a substrate layer 1040;
(v) an adhesive layer 1050 for separably adhering the substrate and the backing layer;
(vi) a non-adhesive backing layer 1060; and
(vii) a stiffener layer 1070, e.g. a base stock such as paper or cardboard.

The clear protective layer 1010 and self-adhesive layer 1020 are formed as an ‘overlaminate’. The overlaminate may be, for example:
(i) a fifty-micron thick clear gloss cast vinyl film, with a maximum dimensional stability of about 0.2 mm, and an ultimate adhesion of about 700 N/m to stainless steel, such as the ‘DOL 1000’ gloss clear cast permanent overlaminate from ‘Avery Dennison’ (URL: http://www.averygraphics.com);
(ii) an eighty-micron thick clear gloss UV stable polymeric calendered vinyl film, with a maximum dimensional stability of about 0.3 mm, and an ultimate adhesion of about 700 N/m to stainless steel, such as the ‘DOL 2000’ gloss clear calendered overlaminate from ‘Avery Dennison’ (URL: http://www.averygraphics.com); or
(iii) a two-mil (0.05-mm) thick film (or three to four mil thick with adhesive), designed for cold roll lamination and having a dimensional stability of about 0.4 mm, such as the ‘Scotchcal 8519’ luster overlaminate or the ‘Scotchcal 8520’ matte overlaminate from ‘3M’ (URL: http://www.scotchprint.com).

The primer forming the primer layer 1030 may be applied by flexo, gravure, rod or roll systems. An example primer is the ‘DigiPrime 4431’ press ready coating from ‘Michelman Inc.’ (URL: http://www.michem.com). An alternative is ‘Topaz’ primer distributed by ‘HP’ (URL: http://www.hp.com).

The printed decorative image is printed, for example, using an electronic printing process and a liquid ink, such as ‘HP ElectroInk’ ink from ‘HP’ (URL: http://www.hp.com).

The substrate layer 1040 is formed of cast vinyl, provided as part of a complete vinyl substrate product comprising the adhesive layer 1050, the backing layer 1060 and stiffener layer 1070. The vinyl substrate product may comprise, for example:
(i) a fifty-three-micron thick high gloss white cast vinyl, with a maximum dimensional stability 0.2 mm, an elongation of more than one hundred percent, and a ‘Grey Easy Apply (EZ)’ removable acrylic adhesive, such as the ‘MPI 1005 EZ’ easy apply removable cast vinyl from ‘Avery Dennison’ (URL: http://www.averygraphics.com); or
(ii) a two-mil thick white removable vinyl film (or three to four mil thick with adhesive), with a clear pressure-activated adhesive that allows for fast and clean removal with little or no residue, and having channels in the adhesive allowing air to be directed outward for easier application and fewer air bubbles, such as the ‘Controltac Plus IJ180C-10’ graphic film, with ‘Comply’ performance adhesive, from ‘3M’ (URL: http://www.scotchprint.com).

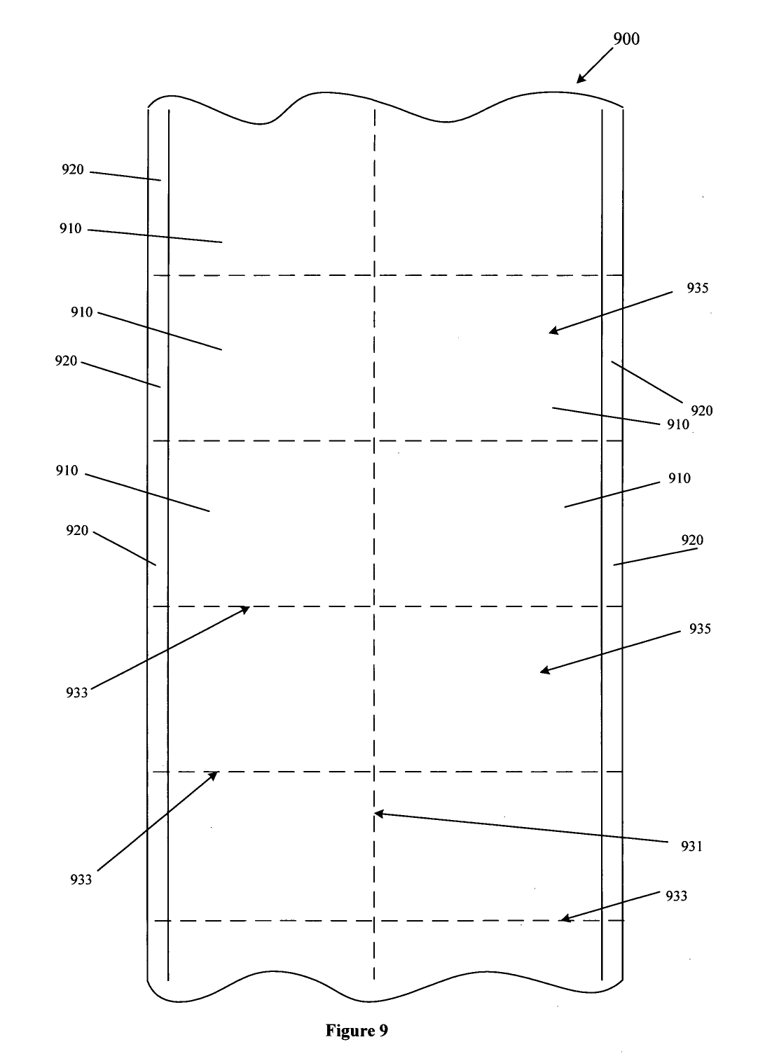

The length of printable material, after the repeated decorative image has been applied, forms a length of printed material 900, including a plurality of the printed decorative images 910, as shown in FIG. 9. For each printed decorative image 910, the length of printed material 900 includes identification indicia 920 on the printed face of the length of printed material 900, e.g. a machine-readable code or a human-readable code associated with the printed decorative image 910 printed on the length of printed material 900. The identification indicia 920 are used for selecting the vinyl sheet of the stored sheets 135 corresponding to the personalised cover selection made by the customer. The length of printed material is cut along cutting lines 931, 933 to divide the length of printed material 900 into individual sheets 935—corresponding to the sheets of the stored sheets 135—for cutting in step 840 of the method of producing a decorative cover for a device, described above with reference to FIG. 8.

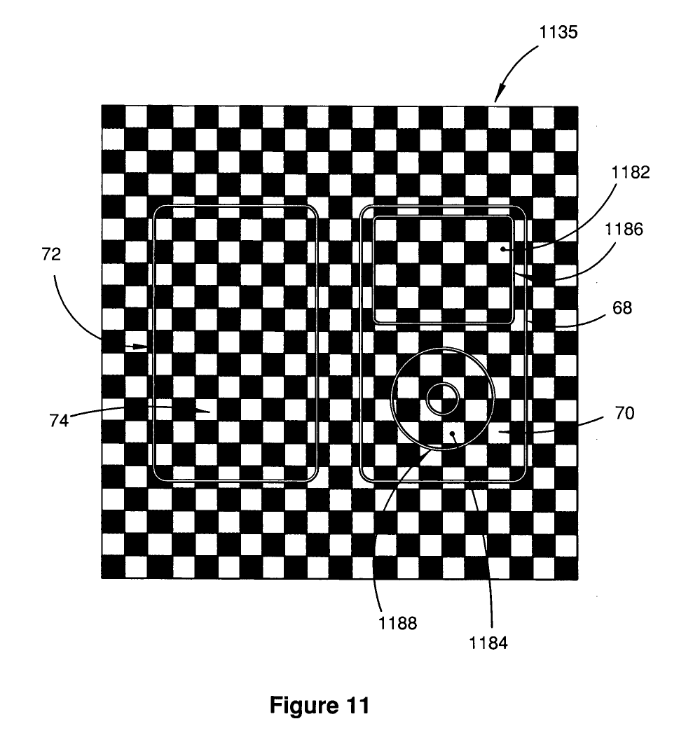

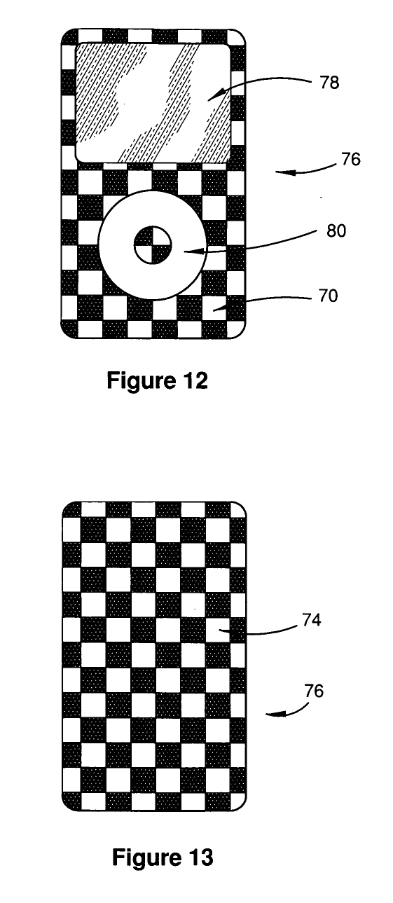

In the process 600,800 for producing a decorative cover for a device, the cutting apparatus 130 produces the sheet cut according to the cutting pattern: for example, the sheet may be cut for use with an example “iPod” music player, as shown in FIG. 11. The cut sheet 1135 includes a back panel 74 for adhesion to the back of the iPod and having visible a checked or chequered pattern. The back panel 74 is separated from the remainder of the cut sheet 1135 by a cutting line 72, being part of the cutting pattern, shaped to conform to the physical dimensions of the iPod. The cut sheet 1135 also includes a front panel 70 which is separated from the rest of the cut sheet 1135 by a cutting line 68, which is also part of the cutting pattern. Window panels 1182, 1184 have outlines defined by cutting lines 1186, 1188 which allow the window panels 1182, 1184 to be separated from the front panel 70 to produce a front panel with windows 78, 80, or hole/gaps, as shown in FIG. 12. The windows 78, 80 allow the user interface components of the decorated device 76, e.g. an iPod with a decorative sticker, to be accessible. The cover, e.g. including the front panel 70 and the rear panel 74 for the example iPod, is sized to decorate the device, e.g. the decorated iPod 76 in FIGS. 12 and 13, as customised and personalised by the customer.

The sheets in the stored sheets 135 are sized according the devices available for selection. In order to cover typical mobile telephones, and devices similar in size, the sheets may have a printed decorative area of, for example, 150 mm square. Stored sheets 135 to be used to cover a larger device, such as a laptop computer for example, are substantially larger. Stored sheets 135 may comprise a side bar having the identification indicia 920 thereon for labelling or identification, with a width of between 1 and 10 mm along one edge of the sheet.

The sheets in the stored sheets 135 are stored in a storage unit and arranged in groups according to sheet size and decorative pattern, allowing for efficient retrieval of sheets for provision to the cutting device 130.

In certain embodiments, the decorative cover is also a protective cover, being comprised of a material that provides protection to the device from damage, such as scratching, minor impacts, liquid penetration, etc.

In particular embodiments, the decorative pattern of the decorative cover is clear, thereby providing a clear, or see-through, cover. The clear cover is sized, for example, to cover a screen of the device, e.g. a screen on a mobile phone, PDA, portable computer, watch, etc. The clear screen cover is also a protective screen cover, providing protection to the screen—and in some cases the surrounding casing of the device—from damage, such as scratching, minor impacts, liquid penetration, etc.

Modifications or enhancements to the embodiments may be apparent to those skilled in the art without departing from the spirit of the embodiments as hereinbefore described with reference to the accompanying drawings. The described embodiments are therefore intended to be exemplary and non-limiting when considered in the context of the appended claims.

1-45. (canceled)

46. A method of producing a decorative cover for a device, the method comprising: receiving selection input at a computerised interface, the selection input comprising a device selection of the device and a cover selection of a decorative cover to be applied to the device;
generating a product order based on the selection input;
providing a sheet to a cutting apparatus, wherein a decorative appearance of the sheet corresponds to the cover selection and the sheet comprises a flexible adhesive backed substrate on which the decorative appearance is printed and a backing layer; and causing the cutting apparatus to cut the substrate based on the product order so that at least one portion of the substrate is separable from a remainder of the substrate and the backing layer to form the decorative cover for adhesive application to the device.

47. The method of claim 46, wherein the generating comprises printing a product specification on a physical medium based on the product order.

48. The method of claim 47, wherein the printing comprises printing a machine-readable code and at least one human-readable code on the physical medium, wherein the machine-readable code is usable by a product sales system to identify the sheet and to process a sale of the sheet, and wherein the at least one human-readable code comprises a sheet identifier to enable human identification of the sheet to be cut by the cutting apparatus.

49. The method of claim 48, wherein one or more of the at least one human-readable code and the machine-readable code comprises a job identifier and wherein the cutting apparatus is configured to cut the substrate based on the job identifier.

50. The method of claim 47, wherein the generating comprises storing a product order file in a memory accessible to the cutting apparatus, the product order file comprising a job identifier and a cutting pattern for cutting the portions of the substrate.

51. The method of claim 50, wherein the causing comprises providing the job identifier to the cutting apparatus and retrieving the product order file from the memory based on matching the provided job identifier with the stored job identifier.

52. The method of claim 46, further comprising presenting at the computerised interface a plurality of device representations and determining the device selection in response to selection of one of the device representations.

53. The method of claim 46, further comprising presenting at the computerised interface a plurality of decorative images and determining the cover selection in response to selection of one of the decorative images.

54. The method of claim 53, further comprising displaying a preview image comprising one of the decorative images applied to a representation of a selected device, wherein the preview image comprises at least one decorative image portion corresponding to the at least one separable portion of the substrate, the at least one decorative image portion being positioned in relation to the representation of the selected device to visually simulate application of the decorative cover to the device.

55. The method of claim 46, wherein the receiving and generating are performed at a customer-accessible computerised kiosk in a retail establishment and the providing and causing are performed at one or more locations within the retail establishment that are not customer-accessible.

56. The method of claim 46, wherein the method is performed within a retail establishment at one or more locations that are not customer-accessible.

57. The method of claim 46, wherein the receiving and generating are performed by a server system in communication with a client system that is remote from a retail establishment in which the providing and causing are performed.

58. A system for producing a decorative cover for a device, the system comprising:
a computerised interface configured to enable receipt of selection input, the selection input comprising a device selection of the device and a cover selection of a decorative cover to be applied to the device, the computerised interface being further configured to generate a product order based on the selection input;
a plurality of sheets, each sheet having a decorative appearance, the decorative appearance of at least one sheet corresponding to the cover selection, wherein each sheet comprises a flexible adhesive-backed substrate on which the decorative appearance is printed and a backing layer; and
a cutting apparatus configured to cut the substrate of a selected one of the sheets based on the product order so that at least one portion of the substrate is separable from a remainder of the substrate and the backing layer to form the decorative cover for adhesive application to the device.

59. The system of claim 58, wherein the plurality of sheets each comprise a clear self-adhesive layer covering a face of the sheet on which the decorative appearance is printed.

60. The system of claim 58, wherein each sheet has printed thereon identification indicia.

61. The system of claim 58, further comprising a printer operably associated with the computerised interface for printing a product specification on a physical medium based on the product order.

62. The system of claim 61, wherein the product specification comprises a machine-readable code and at least one human-readable code, wherein the machine-readable code is usable by a product sales system to identify the sheet and to process a sale of a sheet, and wherein the at least one human-readable code comprises a sheet identifier to enable human identification of the sheet to be cut by the cutting apparatus.

63. The system of claim 62, wherein one of the at least one human-readable code and the machine-readable code comprises a job identifier and wherein the cutting apparatus is configured to cut the substrate based on the job identifier.

64. The system of claim 58, wherein the computerised interface is configured to store in a memory accessible to the cutting apparatus a product order file for each product order, the product order file comprising a job identifier and a cutting pattern for cutting the portions of the substrate, and wherein the cutting apparatus is configured to retrieve the cutting pattern for a sheet based on the job identifier in the product order file in response to input of the job identifier to the cutting apparatus.

65. The system of claim 58, wherein the computerised interface is configured to present a plurality of device representations to enable receipt of the device selection from among the device representations.

66. The system of claim 58, wherein the computerised interface is configured to present a plurality of decorative images to enable receipt of the cover selection from among the decorative images.

67. The system of claim 66, wherein the computerised interface is configured to display a preview image comprising one of the decorative images applied to a representation of a selected device, and wherein the preview image comprises at least one decorative image portion corresponding to the at least one separable portion of the substrate, the at least one decorative image portion being positioned in relation to the representation of the selected device to visually simulate application of the decorative cover to the device.

68. The system of claim 58, wherein the computerised interface is comprised in a customer-accessible kiosk within a retail establishment and the cutting apparatus is located within the retail establishment in a location that is not customer-accessible.

69. The system of claim 58, wherein the computerised interface and cutting apparatus are located within a retail establishment in an area that is not customer-accessible.

70. The system of claim 58, wherein the computerised interface is located remotely from a retail establishment in which the plurality of sheets and the cutting apparatus are located, the computerised interface being in communication with a server system to enable the cutting apparatus to access the product order.

71. A method of producing a protective cover for a device, the method comprising:
receiving selection input at a computerised interface, the selection input comprising a device selection of the device and a cover selection of a protective cover to be applied to the device;
generating a product order based on the selection input;
providing a sheet to a cutting apparatus, wherein the sheet corresponds to the cover selection and the sheet comprises a protective flexible adhesive-backed substrate and a backing layer; and
causing the cutting apparatus to cut the substrate based on the product order so that at least one portion of the substrate is separable from a remainder of the substrate and the backing layer to form the protective cover for adhesive application to the device.
